(19) United States
(12) Patent Application Publication
(10) Pub. No.: US 2009/0211872 A1
(43) Pub. Date: Aug. 27, 2009

(54) APPARATUS AND SYSTEM FOR A TORQUE RESPONSIVE CLUTCH

(76) Inventors: ALBERT J. YOUNGWERTH, Boise, ID (US); Danny S. Youngwerth, Boise, ID (US); Sean Brown, Boise, ID (US)

Correspondence Address: Kunzler & McKenzie, 8 EAST BROADWAY, SUITE 600, SALT LAKE CITY, UT, 84111, US

(21) Appl. No.: 12/372,624

(22) Filed: Feb. 17, 2009

Related U.S. Application Data
(60) Provisional application No. 61/028,705, filed on Feb. 14, 2008.

(51) Int. Cl. F16D 43/10

(52) U.S. Cl. 192/93 A

(57) ABSTRACT

An improved apparatus for varying the pressure applied to a clutch system that can be used to couple a rotational input with a rotational output. Depending on the load and direction of torque in the clutch system, the improved apparatus will engage a spring with more force or less force to affect the amount of torque transferred by the clutch system and the force required by an operator to manually disengage the clutch system.

### CROSS-REFERENCE TO RELATED APPLICATIONS

This application claims priority to U.S. Provisional Patent Application No. 61/028,705 entitled “APPARATUS AND SYSTEM FOR A TORQUE RESPONSIVE CLUTCH” and filed on Feb. 14th, 2008 which is incorporated herein by reference.

### BACKGROUND OF THE INVENTION

This invention relates to a clutch system of the friction type placed in a power transmission system. Typical clutch systems include a clutch input such as a clutch basket, a clutch output such as a center clutch, and one or more plates making up a clutch pack and disposed between the clutch input and clutch output. When the clutch pack is compressed, the clutch input and clutch output become rotationally coupled. The improved clutch system includes means for varying the pressure in the clutch pack to provide for higher torque capacity in the clutch when necessary and lower capacity in the clutch when the higher capacity is not needed or undesirable. Additionally, the lower capacity mode benefits the operator by requiring less force to disengage the clutch system and keep it disengaged. Although the embodiments disclosed are particularly well adapted for use in a multi-plate clutch such as those clutches commonly used in motorcycles, the invention can readily be adapted to other types of clutches such as those used in automobiles, farm implements and other devices.

In the past, a clutch system wherein the frictional force is provided by the force of a spring between the driving friction disk connected to the clutch input member and the driven friction disk connected to the clutch output member, has widely been used. However, in this type of clutch, the set load of the spring must be increased in order to increase the clutch capacity because of restrictions on the diameter of the driving and driven friction disks and the number of disks used. Consequently, clutch decoupling performed against the set load of the spring necessarily requires a greater operating force to the driver's disadvantage.

Improvements to this type of clutch arrangement have been suggested that provide for greater torque capacity in the clutch than the set load of the clutch spring could provide by itself. One type incorporates a helical force generation. Another type uses centrifugal force generation. However, previously disclosed mechanisms have many disadvantages.

Centrifugal clutches require high rotational speeds to provide the required force to increase clutch torque capacity and the effort required to disengage the clutch remains high until rotational speeds are lowered. For powertrains that provide large amounts of torque at relatively low speeds, this configuration will not provide adequate clutch torque capacity at low speeds.

Previous clutch systems that incorporate helical mechanisms to vary pressure in a clutch pack require complex, expensive, multi-piece center clutches. Furthermore, prior art helical clutch mechanisms require that all of the torque transferred by the clutch system must pass through the helical mechanism in addition to the clutch plates. Transferring high levels of torque through the helical mechanism may cause excessive wear or even failure of the helical mechanism.

### BRIEF DESCRIPTION OF THE DRAWINGS

FIG. 1 is an isometric exploded view of a first embodiment of the invention;

FIG. 2a is a cross-sectional view of a first embodiment of the invention.

FIGS. 2b and 2c are detailed views of FIG. 2a;

FIGS. 3a, 3b and 3c are schematic diagrams illustrating cross-sectional views of helical ramps;

FIG. 4 is an isometric exploded view of a second embodiment of the invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention is shown adapted to a typical clutch system as used in modern motorcycles. However, the described invention may also be adapted to function in any vehicle or other implement that requires rotational coupling between two shafts.

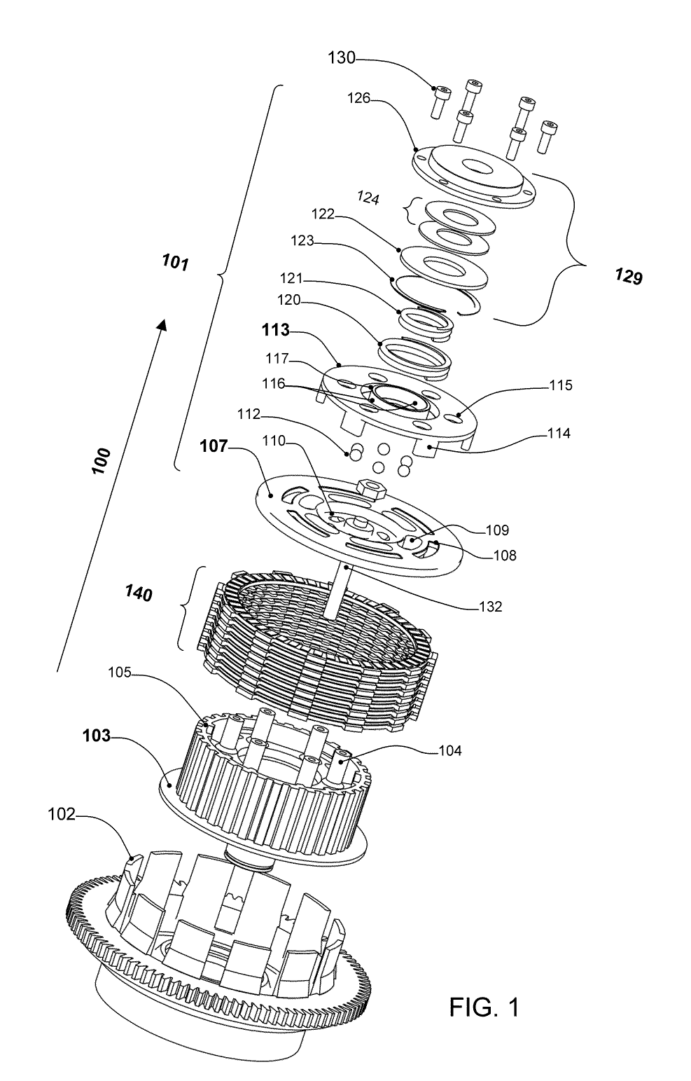

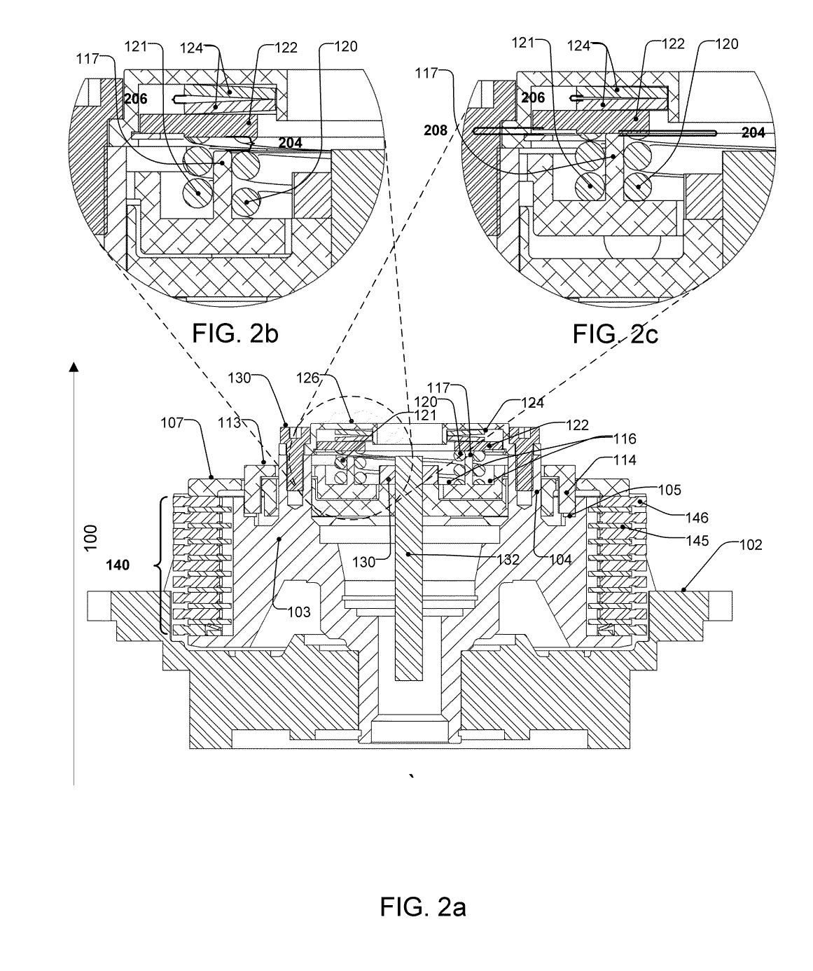

FIG. 1 is an isometric exploded view diagram illustrating an embodiment of a torque responsive clutch apparatus (hereinafter “clutch”) in accordance with the present invention. FIGS. 2a, 2b and 2c are the same embodiment as FIG. 1 in a section view and detailed section views. For clarity purposes, reference will be made to “outward” and “inward” directions. As used herein, the term “outward” refers to a direction parallel to and pointing away from the transmission input shaft, or an axial center of the clutch. Arrow 100 illustrates this outward direction. The term “outward direction” may also refer to a direction normal to and pointing away from the axial center or axis. As used herein “inward” refers to the opposite direction of “outward.”

The clutch, in one embodiment, comprises a clutch input or clutch basket 102, a clutch output or center clutch 103, a clutch pack 140 and an improved torque responsive pressure plate assembly 101 and a pressure plate assembly release mechanism 132. The clutch basket 102, center clutch 103, pressure plate assembly release mechanism 132 and clutch pack 140 are of typical construction. In one embodiment, the clutch basket 102 is coupled to an input, such as an engine and the center clutch 103 is coupled to an output, such as a transmission.

The clutch pack 140 is formed of drive plates 145 and friction plates 146 that when compressed are rotationally coupled and when uncompressed are free to rotate independent of each other. In one embodiment, the drive plates 145 are rotationally coupled to the center clutch 103 and the friction plates 146 are coupled to the clutch basket 102. Alternatively, the clutch pack 140 may comprise any compressible mechanism that when compressed, rotationally couples the center clutch 103 and a clutch basket 102.

The torque responsive pressure plate assembly 101 is spring loaded and normally compresses the clutch pack 140 coupling the clutch basket 102 and center clutch 103 rotationally. The operator may disengage the clutch by activating a lever which in turn pushes the pressure plate assembly release mechanism 132 in an outward direction, moving the improved torque responsive pressure plate assembly 101 away from and releasing pressure on the clutch pack 140.

One embodiment of the improved torque responsive pressure plate assembly 101 consists of a pressure plate bottom 107, pressure plate top 113, helical ramps 110, initial springs 120, 121 and a limit spring assembly 129.

The pressure plate bottom 107 is formed with a surface configured to engage a surface of the clutch pack 140 and provide a compressing or clamping force to the clutch pack 140. The pressure plate bottom 107, in one embodiment, comprises at least one helical ramp 110 configured to receive a ball 112. A corresponding helical ramp is formed in an inward facing surface of the pressure plate top 113 such that the corresponding helical ramps of the pressure plates 107, 113 together maintain one ball 112 per helical ramp. In a further embodiment, the pressure plates 107, 113 comprise a plurality of helical ramps 110 oriented radially about the axial axis. In another embodiment, ramps are formed in the pressure plate bottom 107 and the pressure plate top 113 such that each ramp protrudes from the surface of the pressure plates and is formed so that relative rotation between the two pressure plates causes them to expand.

The pressure plate top 113 further comprises pockets 116, separated into two parts by a limit spring engagement boss 117 for receiving a set of initial springs 120, 121. The initial springs 120, 121, in one embodiment are coil springs. In another embodiment only one initial spring is used. In another embodiment one or more Belleville springs are used as an initial spring. In another embodiment, one or more wave springs are used as an initial spring.

The clutch also includes a limit spring assembly 129. In one embodiment, the limit spring assembly consists of a snap ring 123, a spring washer 122, maximum pressure springs 124, and a limit spring top plate 126. The limit spring assembly 129 is configured so that the snap ring 123 retains the spring washer 122. As can best be seen in FIG. 2b, the spring washer 122, forces the maximum pressure springs 124 into the limit spring top plate so the maximum pressure springs 124 are pre-compressed.

A beneficial characteristic of the Belleville springs is that when the height-to-thickness ratio is greater than a certain amount, the force required to deflect the Belleville spring is very non-linear. For example, the load required to deflect the Belleville spring increases greatly through the first 50% of deflection but does not increase greatly through the final 50% of deflection. Applied to the clutch, a Belleville spring that is pre-compressed or deflected, for example 50% deflection, does not require a great amount of force to lift, or separate, the pressure plate bottom 107 off of the clutch pack 140 in order to disengage the clutch.

The combined force of the initial springs 120, 121 is configured to be less than the force provided by the maximum pressure springs 124. In one embodiment, the force provided by the initial springs 120, 121 is selected to achieve a torque capacity in the clutch that is equal to or slightly greater than a torque capacity sufficient to sustain moderate acceleration of a vehicle or to sustain a moderate continuous load on the vehicle and the force provided by the maximum pressure springs 124 is selected to achieve a torque capacity in the clutch that is equal to or greater than the maximum torque that can be generated by the engine. In another embodiment, the force provided by the initial springs 120, 121 is selected to achieve a torque capacity in the clutch that is equal to or slightly greater than a torque capacity sufficient to sustain maximum acceleration of the vehicle during take-off and the force provided by the maximum pressure springs 124 is selected to achieve a torque capacity in the clutch that is equal to or greater than the maximum torque that can be generated by the engine.

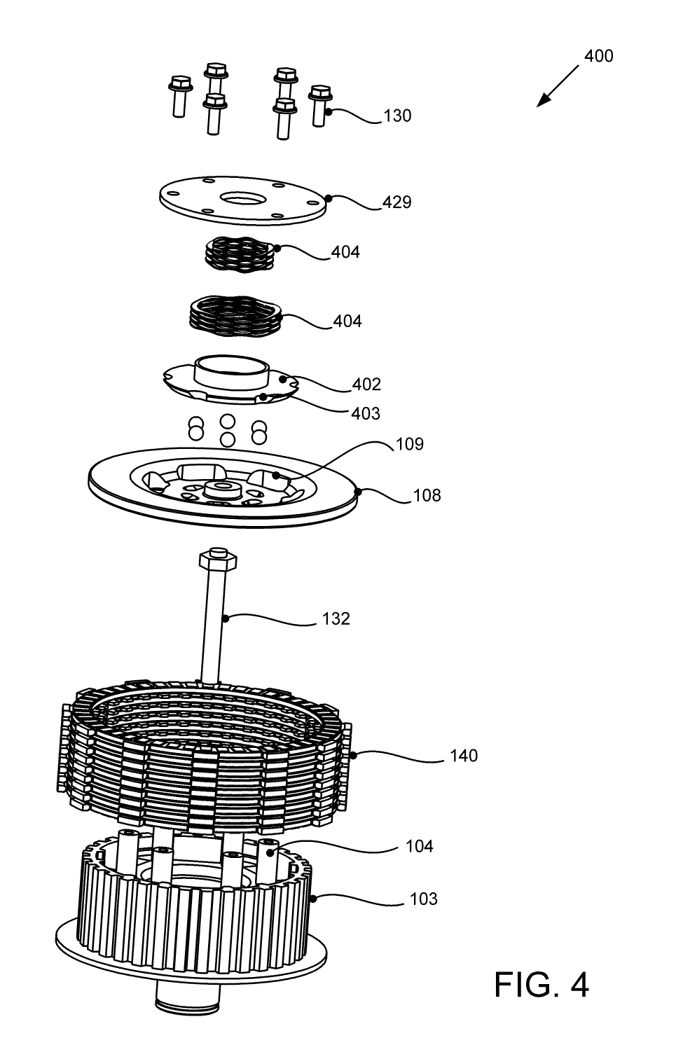

Bolts 130 pass through the limit spring top plate 126 to secure the limit spring assembly 129 to the center clutch 103. As best seen in FIG. 2a, when the bolts 130 are tightened down, the spring washer 122 compresses the initial springs 120, 121. The force of the initial springs pushes downward on the pressure plate top 113, through the balls 110, through the pressure plate bottom 107 and into the clutch pack 140. In another embodiment, the limit spring assembly 129 is replaced by a top plate 429 as shown in FIG. 4. In this embodiment, the limit spring top plate 429 may be configured to also function in a manner similar to the limit spring assembly 129. As such, the limit spring top plate 429 and/or the pressure plate bottom 107 flexes, acting like a spring and provides the clamping force previously provided by the spring assembly 129 in the embodiment of FIG. 1.

The clutch, in a further embodiment, includes a clutch release rod 132 which is coupled with a clutch lever of the vehicle (not shown) on one end and to the pressure plate bottom 107 on the opposite end in order to selectively disengage the clutch pack 140. In another embodiment, the clutch release rod 132 is coupled with a clutch lever of the vehicle (not shown) on one end and to the pressure plate top 113 on the opposite end in order to selectively disengage the clutch pack 140.

In one embodiment, the pressure plate top 113 is configured to be rotationally coupled to the center clutch 103. Tabs 114 on the pressure plate top 113 pass through tab openings 108 in the pressure plate bottom 107 and engage center clutch notches 105 in the center clutch 103. In this way, the pressure plate top 113 is rotationally coupled or “locked” with the center clutch. In this embodiment, the standoff openings 115 are of sufficient diameter so that the center clutch standoffs 104 never rotationally engage the pressure plate top standoff openings 115. In this configuration, during operation of the clutch, rotational torque generated by the pressure plate bottom 107 is transferred to the tabs 114 of the pressure plate top 113 and is never transferred to the standoffs 104 of the center clutch 103.

In another embodiment, depicted in FIG. 4, the pressure plate top 402 includes pressure plate notches 403 that engage the center clutch standoffs 104 to rotationally couple the pressure plate top 402 with the center clutch 103. In this configuration, during operation of the clutch, rotational torque generated by the pressure plate bottom 107 is transferred to the pressure plate top notches 403 and to the standoffs 104 of the center clutch 103.

The pressure plate bottom 107 is configured to allow a small amount of relative rotation between it and the pressure plate top 113 to allow the helical ramps 110 to activate. In one embodiment, the pressure plate bottom 107 is formed with tab openings 108 and standoff openings 109. The pressure plate bottom openings 108, 109 are formed as circular slots so that the pressure plate bottom can rotate a small amount relative to the pressure plate top 113. In this embodiment, the openings are formed such that an edge of the tab opening 108 will engage the edge of the pressure plate top tab 114 before the edge of the standoff opening 109 engages the standoff 104. In this way, the rotation of the pressure plate bottom 107 relative to the pressure plate top 113, is limited. In another embodiment, as is shown in FIG. 4, the pressure plate bottom is formed only with standoff openings 109 and the edge of the standoff openings engage the standoff 104 to limit the relative rotation between the pressure plate bottom 107 and the pressure plate top 113.

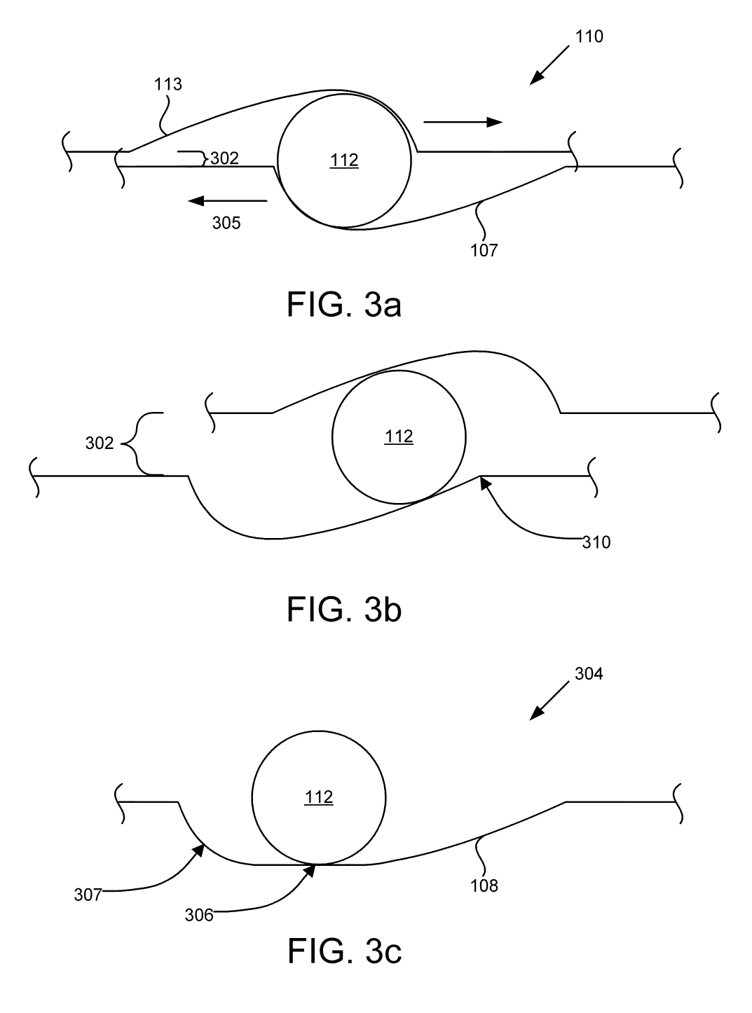

FIGS. 3a, 3b and 3c depict a two dimensional representation of the operation of one embodiment of the helical ramps 110 formed in the pressure plate top 113 and pressure plate bottom 107. FIG. 3a shows the helical ramps 110 with a ball 112 between the helical ramps 110, in a relaxed state. When the pressure plate bottom 107 begins to rotate in a direction as indicated by the arrow 305, while the pressure plate top 113 remains stationary, the ball 112 will climb the helically ramped surfaces 110 formed between the pressure plate top 113 and pressure plate bottom 107 as shown in FIG. 3b, expanding the two parts relative to one another as represented by the increased gap 302.

FIGS. 3a and 3b are diagrams intended to illustrate the function of the helical ramp, and not necessarily the exact shape of the helical ramps 110. The shape and dimensions of the helical ramps 110 are selected in order to prevent continuous slipping when the toque capacity in clutch exceeds the load provided by the initial springs 120, 121 or climbs the helical ramps 110 and engages the maximum pressure springs 124 when the clutch is slipping during initial engagement at moderate loads as during a vehicle take off from a stop. Factors to consider include, but are not limited to, the angle, pitch, and rise of the helical ramps 110. Additional factors include the radius of action of the helical ramps 110, the radius of the clutch pack 140, and the coefficient of friction between the clutch pack 140 and the pressure plate bottom 107. As used herein, the term “slip” refers to a difference in rotational speed between the friction disks 146 and the drive plates 145.

FIG. 3c is a diagram illustrating a cross-sectional view of an alternative ramp in accordance with the present invention. In the depicted embodiment, the ramp 304 includes a flat “run-out” portion 306 configured so that the ball 112 never reaches a tangent point of the helical ramp 307. In this configuration, the tangent point of the helical ramp 307 does not provide a rotational stop for relative motion between the pressure plate bottom and pressure pate top 113; the rotational stop is provided as described below.

In one embodiment, the pressure plate bottom's tab opening 108 width is configured such that relative rotation between the pressure plate bottom 107 and pressure plate top 113 is limited such that the ball 112 can not climb past the end of the ramp 310 as shown in FIG. 3b. In another embodiment, the ramp in the pressure plate bottom 107 is configured with a flat surface 306 and the pressure plate bottom's tab opening 108 width is configured such that relative rotation between the pressure plate bottom 107 and pressure plate top 113 is limited such that the ball 112 can not travel to a tangent point 307 of the pocket as shown in FIG. 3c.

The clutch as depicted in FIGS. 2a and 2b, is shown in a “relaxed” state. In such a state, the initial springs 120, 121 are providing a clamping force to the clutch pack 140 through the pressure plate top 113, through the balls 112 to the pressure plate bottom 107. As shown in FIG. 2b, in the relaxed state, a gap 204 exists between the top of the limit spring engagement boss 117 and the spring washer 122. In one embodiment, the gap 204 is selected such that the distance the limit spring engagement boss 117 of the pressure plate top 113 travels before engaging the spring washer 122 is greater than the distance the pressure plate top 113 and pressure bottom 107 will travel when the clutch lever is activated to disengage the clutch. In this way, only the force of the initial springs need be overcome by the operator to disengage the clutch in the relaxed state.

When the pressure plate bottom 107 is rotated relative to the pressure plate top 113 due to slipping of the friction plates above the set load of the initial springs 120, 121, the helical ramps 110 and the balls 112 between the pressure plate bottom 107 and pressure plate top 113 causes the pressure plate top 113 to move upward. As the pressure plate top 113 rises, the limit spring engagement boss 117 makes contact with the spring washer 122 and further compresses the maximum pressure springs 124 as can best be seen in FIG. 2c. The force of the maximum pressure springs 124 is applied to the clutch pack 140 through the pressure plate top 113, the balls 112 and through the pressure plate bottom 107.

In one embodiment, the vertical distance the pressure plate top 113 rises due to the helical ramps 110 is selected so that when the clutch pack is new and unworn, the maximum pressure springs 124 are compressed to less than solid height 206 as shown in FIG. 2c and when the clutch pack is worn, the spring washer 122 is lifted off of the snap ring 123 so a gap 208 is formed between the snap ring 123 and the spring washer 122 so that all of the force of the maximum pressure springs 124 is transferred to the clutch pack 140. In another embodiment, depicted in FIG. 4, the limit spring engagement boss 117 engages a top plate 429. The top plate material and thickness is selected to deflect slightly, in conjunction with the pressure plate bottom 107 deflecting, to act as a maximum pressure spring. In this embodiment, the vertical distance the pressure plate top 113 rises due to the helical ramps 110 is selected so that when the clutch pack is worn, contact is still made between the limit spring engagement boss 117 and the top plate 429 to provide sufficient clamping force for a maximum pressure spring.

When the vehicle is stopped, the operator will typically disengage the coupling of the clutch basket 102 to the center clutch 103 by engaging a clutch lever (not shown) to lift the improved torque responsive pressure plate assembly 101 away from the clutch pack 140. The operator will then select first gear which will couple the center clutch 103 for rotation with the driving wheels of the vehicle. As the operator begins to release the clutch lever, the pressure plate bottom 107 engages the clutch pack 140 that is spinning with the engine. When the pressure plate bottom 107 begins to engage the clutch pack 140, the top most friction disk 146 applies a rotational torque to the pressure plate bottom 107. The rotational torque is applied to the helical ramps 110 which, through the force of the initial springs 120, 121, resist rotation of the pressure plate bottom 107. In this way, the operator is able get the vehicle moving forward smoothly.

It should also be noted that the torque applied to the helical ramps is limited to the torque supplied by the single friction surface of the top most friction disk 146. The remainder of the torque is applied to the center clutch 103 through the frictional rotational coupling between the remainder of the friction disks 146 and the drive plates 145. In this way, in a multi-plate clutch, the torque transferred to the helical mechanism is greatly reduced. For example in a clutch having 9 friction plates, each friction plate having two sides, the torque transferred by the helical mechanism is 1/18^{th} of the total torque in the clutch.

While the vehicle is moving and the clutch is fully engaged, if the operator applies a large amount of torque to the clutch by rapidly accelerating or through a high load to the vehicle so that the torque in the clutch exceeds the capacity provided by the initial springs 120, 121, the clutch will begin to slip; that is the friction plates 146 will rotate relative to the drive plates 145 and the center clutch 103. When the clutch is slipping in this state, the rotational torque of the top most friction disk 146 against the pressure plate bottom 107 is sufficient for the helical ramps to overcome the force of the initial springs 120, 121 and cause the pressure plate top to lift, engaging the higher force of the maximum pressure springs 124. The helical ramp angle is selected so that the axial force generated to lift the pressure plate top is in a greater proportion than the torque generated by the top most friction disk 146 slipping against the pressure plate bottom 107. The pressure plate top will continue to lift until the clutch stops slipping or the pressure plate bottom 107 rotates until the edge of the tab openings 108 in the pressure plate bottom 107 engage the tabs 114 of the pressure plate top 113 to prevent further rotation.

When the pressure plate top 113 has engaged the maximum pressure springs 124, the operator must overcome the force of the maximum pressure springs 124 to initially disengage the clutch. As the operator engages and applies pressure to the clutch lever, pressure between the pressure plate bottom 107 and the clutch pack 140 is reduced. Additionally, due to pressure in the helical ramps 110 from the maximum pressure springs 124, the pressure plate top 113 is applying a rotational torque to the pressure plate bottom 107 in a direction opposite to that applied by the top-most friction disk 146. When enough pressure has been released between the pressure plate bottom 107 and the top-most friction disk 146, the pressure plate bottom will rotate due to the reverse torque supplied by the helical ramps 110 and the pressure plate top 113 will move downward to the relaxed position. When the pressure plate top 113 is in the relaxed state, the effort required by the operator to keep the clutch disengaged is reduced to that effort required to overcome the initial springs 120, 121. In practice, when the improved torque responsive pressure plate assembly 101 has engaged the maximum pressure springs 124, the operator feels a “click” in the lever as it is disengaged and the pressure plate bottom rotates and then the effort to keep the clutch disengaged is only affected by the initial springs 120, 121.

In practice, when operating a vehicle with the improved torque responsive pressure plate assembly 101, the effort required by the driver to operate the clutch is much lower than with a conventional clutch mechanism. In a conventional clutch mechanism, the clutch spring force is selected so that the torque capacity of the clutch is slightly higher than the peak torque the engine can generate. However, for most drivers, peak engine torque is very seldom used. In typical operation, the driver may only be using one fourth to one third of the peak torque of the engine. With the conventional clutch mechanism, the driver is always subjected to disengaging a clutch spring with a much higher force than is required for typical driving. With the improved torque responsive pressure plate assembly 101, the effort required by the driver to disengage the clutch in most situations is significantly reduced to that of the initial springs 120, 121. When higher torque levels are needed, the driver is only subjected to the higher forces of the maximum pressure springs 124 momentarily when the driver disengages the clutch.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A torque responsive clutch apparatus comprising: an initial spring, a: maximum pressure spring and a thrust mechanism; wherein said initial spring provides a compressive force to a clutch to provide a lower capacity of rotational torque to said clutch and wherein when said rotational torque in said clutch exceeds said lower capacity said thrust mechanism engages said maximum pressure spring to apply a compressive force to said clutch pack to provide a higher capacity of rotational torque to said clutch.

2. The torque responsive clutch apparatus of claim 1 wherein said thrust mechanism is comprised of a pressure plate bottom, a pressure plate top and a helical ramping mechanism disposed between said pressure plate bottom and said pressure plate top.

3. The torque responsive clutch apparatus of claim 2 wherein said pressure plate top is rotationally fixed to the output of said clutch.

4. The torque responsive clutch apparatus of claim 1 further comprising a clutch release mechanism for selectively disengaging said clutch.

5. A torque responsive clutch comprising: a clutch input, a clutch output, a clutch pack, and an initial spring, said initial spring configured to provide a compressive force to said clutch pack so as to provide a lower capacity of rotational torque between said clutch input and said clutch output; further comprising a pressure plate bottom, a pressure plate top, and a thrust mechanism disposed between said pressure plate top and said pressure plate bottom, wherein when the rotational torque between said clutch input and said clutch output is greater than said lower capacity, said pressure plate bottom rotates relative to said pressure plate top causing said thrust mechanism to apply a greater compressive force to said clutch pack than is provided by said initial springs so as to provide a higher capacity of rotational torque between said clutch input and said clutch output.

6. The clutch of claim 5 wherein said pressure plate top is coupled rotationally to said clutch output.

7. The clutch of claim 5 including a clutch release mechanism for selectively disengaging said clutch input from said clutch output.

8. The clutch of claim 5 including a maximum pressure spring, said helical mechanism configured to apply the force of said maximum pressure spring to said clutch pack to achieve said higher capacity.

9. The clutch of claim 8 including a clutch release mechanism for selectively disengaging said clutch input from said clutch output.

10. The clutch of claim 9 wherein said clutch input is rotationally coupled to an engine and said clutch output is rotationally coupled to a transmission.
